(19) United States
(12) Patent Application Publication
(10) Pub. No.: US 2007/0273821 A1
(43) Pub. Date: Nov. 29, 2007

(54) Displaying System Having a Sealing Structure

(75) Inventors: Shang-Rong Liou, Hsinchu City (TW); Chun-Cheng Chen, Miaoli County (TW); Tai-Yuan Chang, Taichung County (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: TOPPOLY OPTOELECTRONICS CORP., Maio-Li County (TW)

(21) Appl. No.: 11/420,129

(22) Filed: May 24, 2006

(51) Int. Cl. G02F 1/1339

(52) U.S. Cl. 349/153

(57) ABSTRACT

The present invention relates to displaying system having a display panel which comprises a sealing structure adapted for assembling a first substrate to a second substrate in an ODF process. The sealing structure comprises a sealant, applied between the substrates, and the panel comprises a black matrix, disposed along the first substrate, with a slot or windows disposed thereon for facilitating the passage of UV light. The sealant is at least partially exposed from the black matrix for curing by the UV light, which is projecting from the outer side of the first substrate. By using the mentioned structure, the dimensions of the LCD frame could be diminished, so that the displaying region could be efficiently utilized.

### CROSS-REFERENCES TO RELATED APPLICATIONS

Not applicable

### BACKGROUND OF THE INVENTION

1. Field of the Invention

The present invention relates to a system for displaying images, more specifically, to a displaying system having a sealing structure for use in association with a black matrix in a one drop fill (ODF) process.

2. Descriptions of the Related Art

Liquid crystal injection is an important process in assembling a liquid crystal display (LCD). Conventionally, liquid crystal has been filled between substrates and reaches the desired locations through capillarity. Unfortunately, this conventional technology is not time and cost effective in view of the assembly procedures. An ODF process, as shown in FIG. 1, was employed as an improved method for uniformly dispensing liquid crystal between the substrates. Basically, in an ODF process, a first substrate 11 and a second substrate 13 are independently disposed. A sealant 15 is circumferentially disposed on the second substrate 13 while the liquid crystal 17 is dispensed therein by an ODF process. After, the first substrate 11 and the second substrate 13 are aligned with each other and assembled in position. Finally, the sealant 15 is cured by UV light which may come from either the side of the first substrate 11 (as shown in FIG. 2B) or the side of the second substrate 13. In the case that the UV light comes from the side of the second substrate 13, which bears complicated structures and is not light transmissible, an intrinsic arrangement to expose the sealant through the second substrate 13 or a TFT array 16 (such as forming a transparent area with ITO treatment under the sealant 15) should be prepared before the assembling process. Still, this manufacturing process makes it difficult to control the overall quality and manufacture the product efficiently.

Please simultaneously refers to FIG. 2A and FIG. 2B. FIG. 2A is a schematic top view of a conventional display panel and FIG. 2B is a schematic cross-sectional view illustrating a conventional display panel along line 2B-2B′ of FIG. 2A. A known color filter matrix 14 and a black matrix 19, which is utilized to provide opaque regions blocking undesired sorts of lights, are disposed under the first substrate 11. It is noted that the color filter matrix 14 is disposed at the active area. In the case that the UV light comes from the side of the first substrate 11, the sealant 15 is disposed at the peripheral area, as in FIG. 2B, without being shielded by the black matrix 19 in order for the sealant to be exposed to the UV light for curing. That is to say, the black matrix 19 should not overlap with the sealant 15. To meet the necessary curing requirement, the adequate areas of the sealant which need to be exposed to the UV light would cause an active area for displaying images to be limited in dimension. An another aspect, the mentioned arrangement compensates by increasing the space in which the curable sealant would occupy, adversely resulting in a larger LCD panel dimension, if the active area for displaying images is desired to be unchanged. It follows that the overall LCD product would be more bulky and less competitive.

Given the above, an inventive system for displaying images which may provide a larger active display area in a desired limited space needs to be developed in this field.

### SUMMARY OF THE INVENTION

An embodiment of this invention provides a system comprising a display panel that comprises a sealing structure adapted for assembling a first substrate to a second substrate by a sealant in an ODF process. The first substrate has a first frame region, while the second substrate has a second frame region. The sealant is then applied therebetween. The display panel comprises a black matrix disposed along at least a part of the first frame region of the first substrate and the sealant is at least partially exposed out of the black matrix for curing by the UV light, which is projecting from the outer side of the first substrate.

Another embodiment of this invention is to provide an LCD module comprising the above-mentioned sealing structures. The LCD module further includes a housing or a bezel which is provided with light blocking elements (such as a black circumferential stripe) disposed correspondingly to the black matrix to make up for any light leakage from the color filter matrix through the openings of the black matrix formed by curing the sealant.

The detailed technology and embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating the assembled structure of a first substrate and a second substrate in an ODF process;

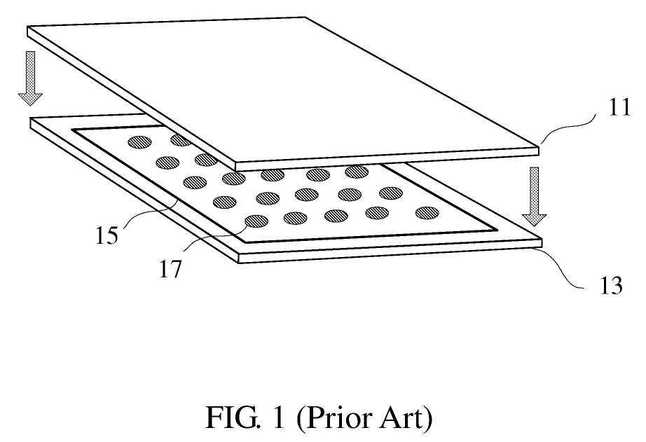

FIG. 2A is a schematic top view of a conventional display panel;

FIG. 2B is a schematic cross-sectional view illustrating the conventional display panel along line 2B-2B′ of FIG. 2A;

FIG. 3A is a schematic top view of a display panel according to an embodiment of the present invention;

FIG. 3B is a schematic cross-sectional view illustrating a display panel along line 3B-3B′ of FIG. 3A;

FIG. 4 is a schematic view illustrating a circumferential slot on a segment of the black matrix;

FIGS. 5A and 5B are schematic views illustrating a plurality of windows with different shapes on a segment of the black matrix;

FIG. 6 is a schematic cross-sectional view illustrating the intermediately disposed sealant with full exposure under the black matrix;

FIG. 7 is a schematic cross-sectional view illustrating the manner in which the sealant is shielded partially out by the black matrix;

FIG. 8 is a schematic cross-sectional view illustrating the intermediately disposed sealant with partial exposure under the black matrix; and

FIG. 9 is a schematic view illustrating the system of the present invention.

### DESCRIPTION OF THE PREFERRED EMBODIMENT

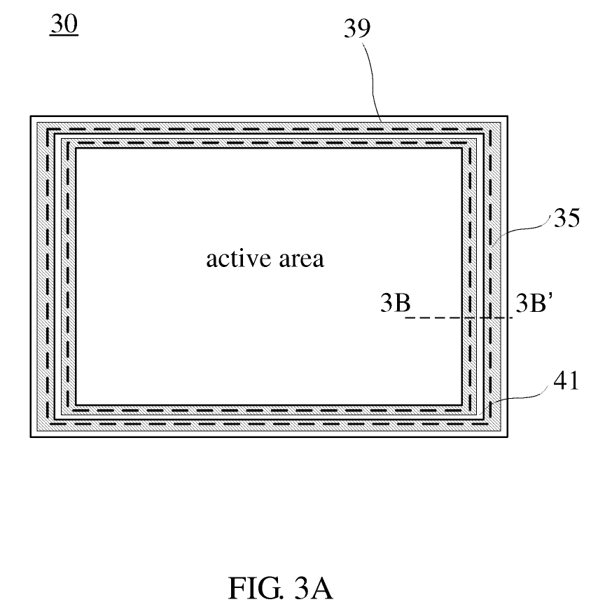

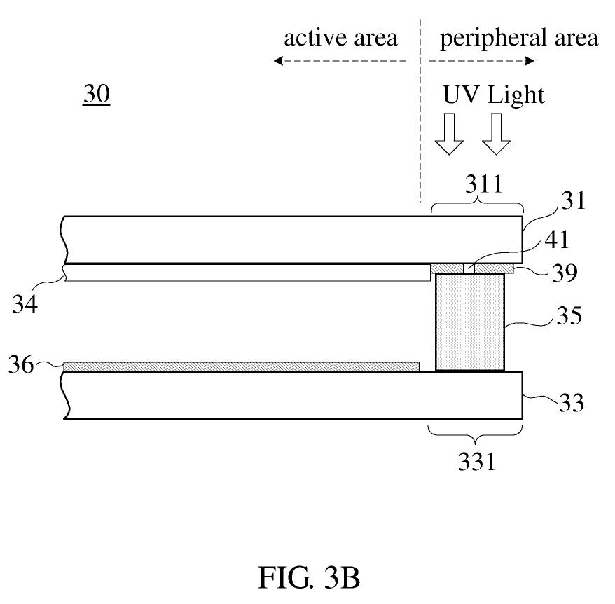

FIG. 3A is a schematic top view of a display panel 30 according to an embodiment of the present invention and a schematic cross-sectional view illustrating the display panel 30 along line 3B-3B′ is shown in FIG. 3B. The display panel 30 comprises a first substrate 31, a second substrate 33, a color filter matrix 34, a TFT array 36, a sealing structure, and a black matrix 39. The sealing structure adapted for assembling the first substrate 31 to the second substrate 33 by a sealant 35 in an ODF process. With reference to FIG. 3B, the embodiment shows that the sealant 35 overlays with the black matrix 39, which has a slot 41. In this embodiment, the first substrate 31, under which disposed the color filter matrix 34, has a first frame region 311, and the second substrate 33, above which disposed the TFT array 36, has a second frame region 331. The sealant 35 is applied between the first frame region 311 and the second frame region 331. The black matrix 39 is continuously disposed along the first frame region 311 of the first substrate 31, on an inner surface as shown. In FIG. 3A schematically showing the top of the display panel 30 of this embodiment, the sealant 35 is shown by the area defined between circumferential broken lines.

In this embodiment, for the UV light to pass through the black matrix 39 to photosensitize and cure the sealant 35, openings formed on the black matrix 39 are needed. In this case, the black matrix 39 is, but not limited to, formed with the circumferential slot 41 along the first frame region 311, through which the sealant 35 can be exposed.

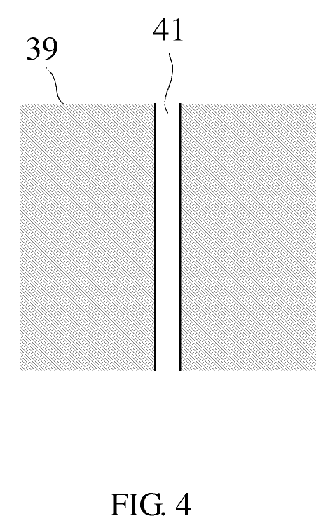

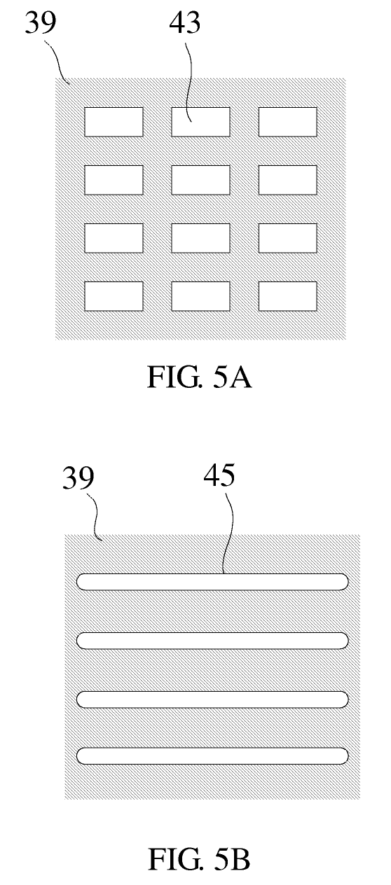

A top view of the slot 41 on a segment of the black matrix 39 is illustrated in FIG. 4. As another example, the black matrix 39 is, but not limited to, formed with a plurality of windows 43, 45, resulting in two alternative ways, shown in FIGS. 5A and 5B, through which the sealant 35 can be exposed to the UV light. The windows 43, 45 can be any kind of hole or groove contour, as long as it follows the desired arrangement for appropriate UV light exposure.

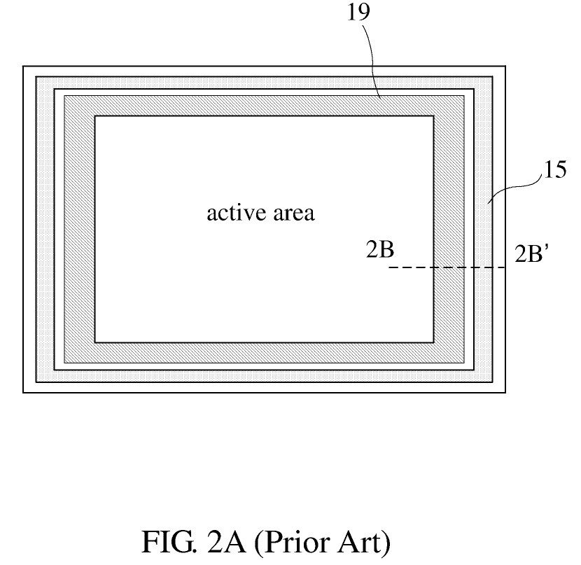

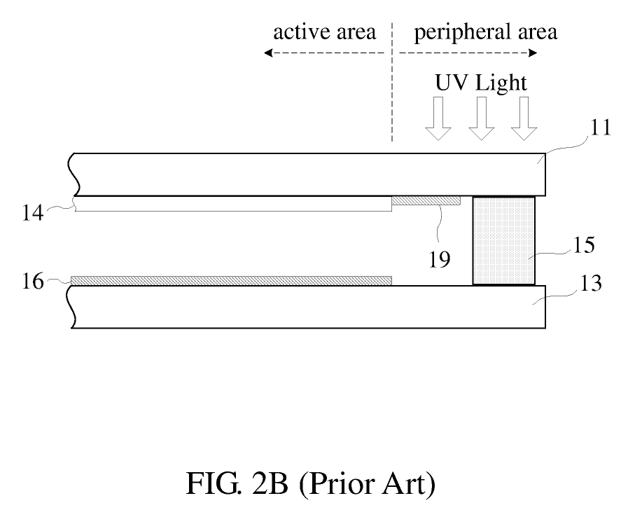

The material used for the sealant 35 is selected from the group of photosensitive resins, or other photosensitive materials, such as Type 717 manufactured by Kyoritsu Chemical Co., Ltd, U98T-3 manufactured by Nippon Kayaku Co., Ltd, or SWB-10 manufactured by Sekisui Co., Ltd. The desired UV light passage ratio under which the slot 41 or the windows 43, 45 needs to be formed on the black matrix 39 depends on the materials as employed for the sealant 35. This is because different materials may require different dimensions of exposure areas for curing the sealant 35. As compared with the conventional structure as shown in FIG. 2A and FIG. 2B, the arrangement according to the present invention offers a larger active area as shown in FIG. 3A and FIG. 3B.

It is understandable that the black matrix 39 can be disposed along the first frame region 311 of the first substrate 31 in a continuous manner or in another manner, as long as the black matrix 39 may perform its inherent purposes of blocking the undesired light.

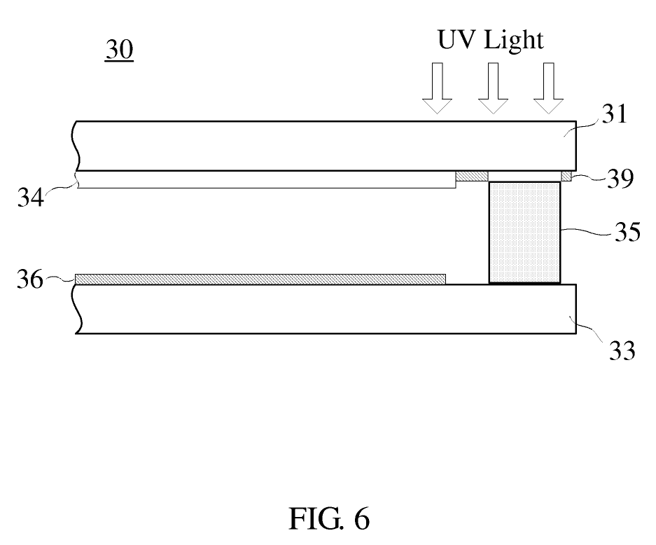

FIG. 6 illustrates a cross-sectional view of another embodiment which shows the sealant 35 with full exposure under the black matrix 39. In this embodiment, the comparatively greater UV light passage ratio is especially suitable for a sealant material that has a lower capability of photosensitivity. This embodiment also makes it possible to more efficiently diminish the panel dimensions because the sealant 35 does not share extra space in view of the planar space of the black matrix existing in the original design.

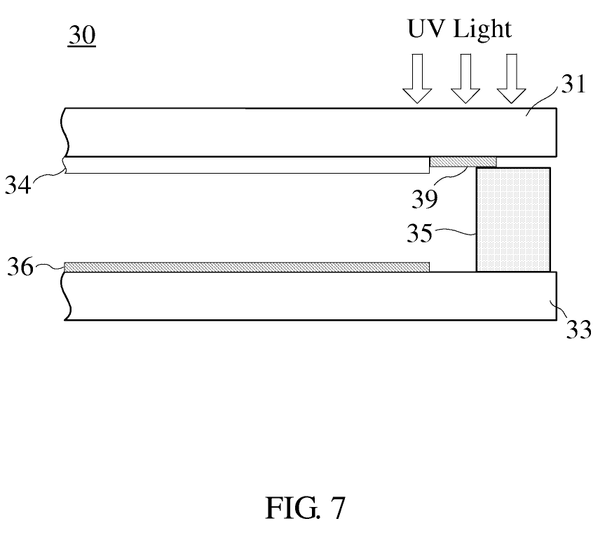

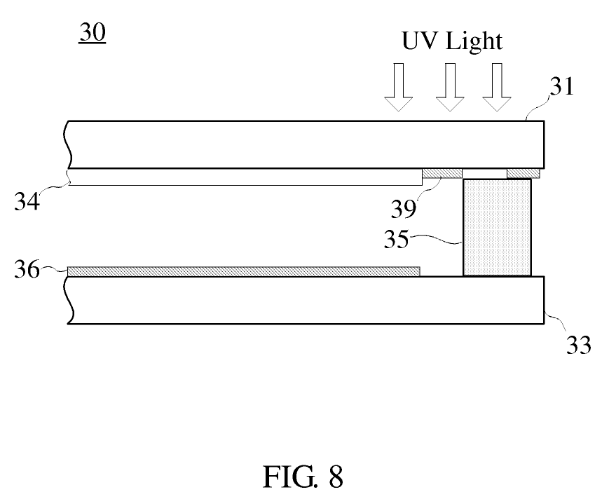

FIG. 7 illustrates a cross-sectional view of another embodiment which shows the sealant 35 partially exposed out of the outer end of the black matrix 39, with an inner portion thereof overlaid by the black matrix 39. FIG. 8 illustrates a further embodiment that shows a sealant 35 disposed under the black matrix, with an outer portion thereof overlaid by the black matrix 39. Additional light blocking elements, such as black circumferential stripes, can be selectively disposed at the housing or bezel of an LCD module which uses the sealing structures as mentioned in the above embodiments. The light blocking elements are provided in positions corresponding to the black matrix, in order to make up for any light leakage from the color filter matrix through the openings of the black matrix formed by curing the sealant. An alternative way to introduce the additional light blocking elements is to employ a sealant 35 which has a dark (e.g. black) color.

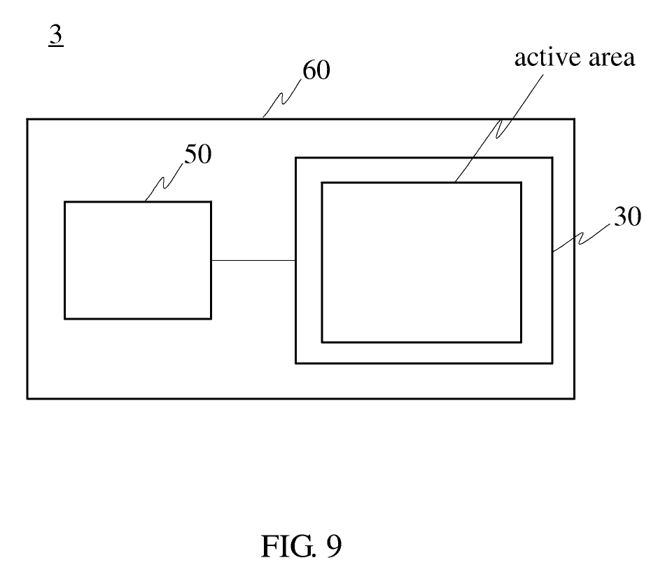

The above-mentioned sealing structure of the display panel 30 could be assembled with any kind of components to form the system 3. As shown in FIG. 9, the system 3 for displaying images further comprises an electronic device 60 which includes an input device 50 coupled to the display panel 30 for providing the displaying images. The electronic device is, but is not limited to be, a PDA, a display monitor, a notebook computer, a tablet computer, a digital camera, a television, a car display, a portable DVD player, a cellular phone or the equivalent multi-functional device with the combination thereof.

According to the present invention, the sealing structure of the display panel 30 would result in a relatively larger active area, on a same-size display panel construction, or a relatively more compact panel dimension, on a same-size active area. In brief, the displaying region could be better utilized through the arrangement of the present invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A system for displaying images, comprising a display panel, the display panel comprising:
a first substrate, having a first frame region;
a second substrate, having a second frame region;
a sealing structure adapted for assembling the first substrate to the second substrate by a sealant applied between the first frame region and the second frame region; and
a black matrix, disposed along at least a part of the first frame region of the first substrate;
wherein the sealant is at least partially exposed out of the black matrix.

2. The system as claimed in claim 1, further comprising a color filter matrix disposed on the first substrate and a TFT array disposed on the second substrate.

3. The system as claimed in claim 2, wherein the black matrix is disposed between the first substrate and the second substrate.

4. The system as claimed in claim 3, wherein the sealant is disposed overlaid with the black matrix and the sealant is completely exposed out of the black matrix.

5. The system as claimed in claim 3, wherein the black matrix is formed with a circumferential slot through which the sealant is partially exposed.

6. The system as claimed in claim 3, wherein the black matrix is formed with a plurality of windows through which the sealant is partially exposed.

7. The system as claimed in claim 1, further comprising an electronic device which includes:
the display panel; and
an input device coupled to the display panel and operative to provide input to the display panel, thereby providing the displaying images.

8. The system as claimed in claim 7, wherein the electronic device is selected from the group of a PDA, a display monitor, a notebook computer, a tablet computer, a digital camera, a television, a car display, a portable DVD player, a cellular phone, and the combination thereof.
